(19) United States
(12) Patent Application Publication
(10) Pub. No.: US 2009/0128914 A1
(43) Pub. Date: May 21, 2009

(54) Diffuser plate, backlight and display have the same

(76) Inventors: Kyung Joon Lee, Uiwang-si (KR); Illia Borysov, Uiwang-si (KR); Seung Man Choi, Uiwang-si (KR); Man Suk Kim, Uiwang-si (KR); Chul Goo Chi, Uiwang-si (KR); Jae Han Kim, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,638

(22) Filed: Oct. 31, 2008

(30) Foreign Application Priority Data
Oct. 31, 2007 (KR) 10-2007-0109946

(51) Int. Cl. G02B 23/00; G02F 1/1335

(52) U.S. Cl. 359/599; 349/64

(57) ABSTRACT

A diffuser plate includes a first optical sheet having a rear surface configured to receive light from a light source and having a front surface configured to provide light to a second optical sheet, the first optical sheet having a predetermined pattern formed by a plurality of transmissive regions and a plurality of reflective regions, and a second optical sheet disposed in front of the first optical sheet, the second optical sheet including a rear surface configured to receive light from the first optical sheet, a front surface configured to emit light, and lenticular lenses on the front surface of the second optical sheet.

### BACKGROUND OF THE INVENTION

1. Field of the Invention

Embodiments relate to a diffuser plate, a backlight and a display having the same.

2. Description of the Related Art

Low power consumption and high luminance are important issues for liquid crystal display (LCD) devices, e.g., televisions, computer monitors, handheld devices, etc. Typically, LCD devices include a backlight unit, the characteristics of which may have a significant impact on power consumption and luminance.

Types of backlight units include a direct type backlight unit, in which lamps are disposed under a liquid crystal panel, and an edge type backlight unit, in which a light guide is installed under a liquid crystal panel and lamps are disposed at one end of the light guide. The direct type backlight unit has a high light utilization efficiency and a simple configuration, and is not limited to a particular size of display surface, thus being widely used in large-scale LCDs.

FIG. 16 illustrates an exploded perspective view of a structure of a general LCD.

With reference to FIG. 16, the LCD includes a liquid crystal panel 10 and a backlight unit 20. Liquid crystal cells are arranged in a matrix on the liquid crystal panel 10 such that light transmittance is adjusted by applying an electric field, and polarizing plates 11 that change light emitted from the backlight unit 20 to polarized light are respectively attached to upper and lower surfaces of the liquid crystal panel 10. The backlight unit 20 includes lamps 21 serving as light sources, a reflection plate 22, a diffuser plate 23, and optical sheets 24. A plurality of the lamps 21 may be provided to emit light.

The diffuser plate 23 serves to diffuse light emitted from the lamps 21 so as to prevent Becke's lines (bright lines) of the lamps 21 from being seen. Beads may be added into the diffuser plate 23 to diffuse light. However, a large amount of the beads may be necessary to prevent the images of the lamps 21 from being seen by the viewer.

The thickness of liquid crystal displays has been gradually thinned to provide a thin profile and light weight. Accordingly, reduced-thickness backlight units have been developed. As a result, the distance between light sources and a diffuser plate in the backlight unit has been reduced. When the distance between the light sources and the diffuser plate is reduced, a diffuser plate that relies on beads for diffusion has a limited ability to diffuse the light sources, such that images of the light sources, i.e., “hot spots” or brightly-lit regions, are generated at positions corresponding to the light sources. Accordingly, there is a need for a diffuser plate suitable for use in a thin backlight unit and capable of reducing or eliminating images of light sources in the backlight.

### SUMMARY OF THE INVENTION

Embodiments are therefore directed to a diffuser plate, a backlight and a display having the same, which substantially overcome one or more of the problems due to the limitations and disadvantages of the related art.

It is therefore a feature of an embodiment to provide a diffuser plate configured to reduce a thickness of a backlight unit.

At least one of the above and other features and advantages may be realized by providing a diffuser plate, including a first optical sheet having a rear surface configured to receive light from a light source and having a front surface configured to provide light to a second optical sheet, the first optical sheet having a predetermined pattern formed by a plurality of transmissive regions and a plurality of reflective regions, and a second optical sheet disposed in front of the first optical sheet, the second optical sheet including a rear surface configured to receive light from the first optical sheet, a front surface configured to emit light, and lenticular lenses on the front surface of the second optical sheet.

The plurality of transmissive regions of the predetermined pattern may be on the rear surface of the first optical sheet, and the plurality of reflective regions of the predetermined pattern may be on the rear surface of the first optical sheet. The first optical sheet and the second optical sheet may be spaced apart by a predetermined interval. The transmissive regions and the reflective regions combined may occupy an entire surface of the first optical sheet.

An area percentage of the first optical sheet occupied by the reflective regions may vary across the first optical sheet. The area percentage of the first optical sheet occupied by the reflective regions may be greater in areas directly over a light source than in areas farther away from the light source.

The reflective regions may be dot-shaped regions, and the transmissive regions may be regions surrounding the dot-shaped reflective regions. The dot-shaped reflective regions may be arranged in a rectangular pattern, a radial pattern, or a hexagonal pattern. An area percentage of the first optical sheet occupied by the dot-shaped reflective regions may vary across the first optical sheet.

The transmissive regions may be dot-shaped regions, and the reflective regions may be regions surrounding the dot-shaped transmissive regions. The dot-shaped transmissive regions may be arranged in a rectangular pattern, a radial pattern, or a hexagonal pattern. An area percentage of the first optical sheet occupied by the dot-shaped transmissive regions may vary across the first optical sheet.

The reflective regions may include a reflective material having at least one of titanium oxide, silver, and calcium carbonate. The lenticular lenses may have a semi-circular or semi-oval cross-section. The lenticular lenses may have a semi-oval cross section, and the semi-oval cross section may have a ratio of major axis length to minor axis length of about 1:1 to about 5:1.

The lenticular lenses may have a pitch and a height, and a pitch:height ratio is about 1:0.5 to about 1:1. The lenticular lenses may be an array of cylindrical lenses having a semi-circular or semi-oval cross-section, and a ratio of pitch to height of the lenticular lenses may be uniform throughout the array.

The diffuser plate may further include optical beads disposed between the transmissive regions and the lenticular lenses.

At least one of the above and other features and advantages may also be realized by providing a backlight unit, including a light source unit including at least one light emitting device, a diffuser plate, and a reflection plate disposed to reflect light emitted from the light source unit toward the diffuser plate. The diffuser plate may include a first optical sheet having a rear surface configured to receive light from a light source and having a front surface configured to provide light to a second optical sheet, the first optical sheet having a predetermined pattern formed by a plurality of transmissive regions and a plurality of reflective regions, and a second optical sheet disposed in front of the first optical sheet, the second optical sheet including a rear surface configured to receive light from the first optical sheet, a front surface configured to emit light, and lenticular lenses on the front surface of the second optical sheet, and the first optical sheet may have predetermined pattern formed by a plurality of transmissive regions and a plurality of reflective regions.

An area percentage of the first optical sheet occupied by the reflective regions may vary across the first optical sheet. The area percentage of the first optical sheet occupied by the reflective regions may be greater in areas directly over a light source than in areas farther away from the light source.

At least one of the above and other features and advantages may also be realized by providing a liquid crystal display device, including a liquid crystal display panel having a viewing side and a backlit side, and a backlight unit according to an embodiment disposed adjacent to the backlit side.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates an exploded perspective view of a diffuser plate including a first optical sheet and a second optical sheet according to an embodiment;

FIG. 2 illustrates a perspective view of a rear surface of a first optical sheet according to an embodiment;

FIGS. 3 to 5 illustrate respective plan views of disposition patterns of dot-shaped reflective regions according to embodiments;

FIGS. 6 to 8 illustrate respective plan views of disposition patterns of dot-shaped transmissive regions according to embodiments;

FIG. 9 illustrates a perspective view of a structure of a second optical sheet in accordance with an embodiment;

FIG. 10 illustrates a longitudinal-sectional view of a path of light passing through a second optical sheet in accordance with an embodiment;

FIG. 11 illustrates a longitudinal-sectional view of a structure of a backlight unit according to an embodiment;

FIG. 12 illustrates a graph of a simulation result of illuminance distribution in a comparative example;

FIG. 13 illustrates a graph of a simulation result of luminance distribution in the comparative example;

FIG. 14 illustrates a graph of a simulation result of illuminance distribution in an experimental example;

FIG. 15 illustrates a graph of a simulation result of luminance distribution in the experimental example; and

FIG. 16 illustrates an exploded perspective view of a general LCD.

### DETAILED DESCRIPTION OF THE INVENTION

Korean Patent Application No. 10-2007-0109946, filed on Oct. 31, 2007, in the Korean Intellectual Property Office, and entitled: “Diffuser Plate Having Reflective regions and Lenticular Lenses,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A diffuser plate including one optical sheet having reflective regions on the rear surface thereof and another optical sheet having lenticular lenses on the front surface thereof in accordance with an embodiment will now be described in detail with reference to the drawings.

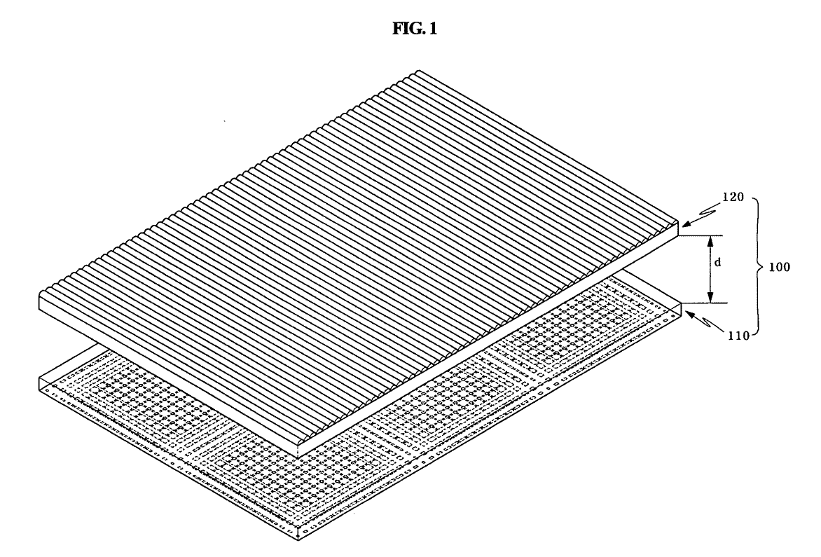

FIG. 1 illustrates an exploded perspective view of a diffuser plate including a first optical sheet and a second optical sheet according to an embodiment.

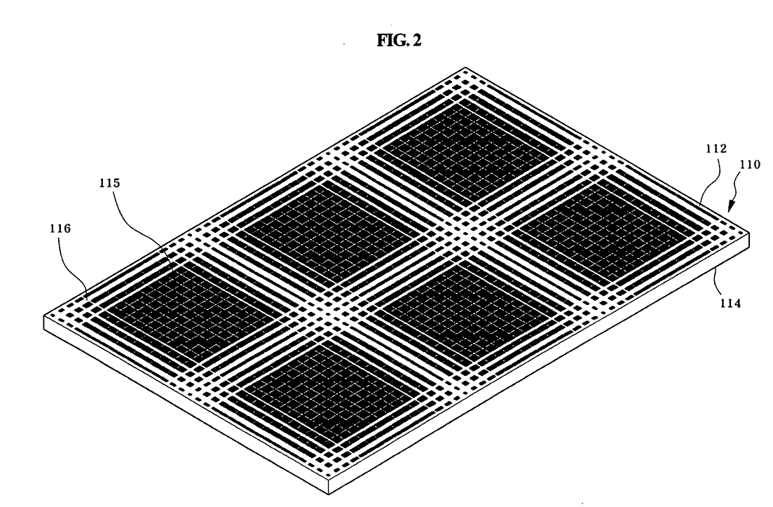

Referring to FIGS. 1 and 2, a diffuser plate 100 according to an embodiment may include a first optical sheet 110 and a second optical sheet 120, which may be spaced apart at a predetermined interval (d).

When diffuser plate 100 is applied to a backlight unit, the first optical sheet 110 may be disposed adjacent to light sources (see FIG. 11), and the second optical sheet 120 may be disposed above the first optical sheet 110, with the first optical sheet 110 and the second optical sheet 120 being separated from each other by the predetermined interval (d).

Light emitted from the light sources may sequentially pass through the first optical sheet 110 and the second optical sheet 120. Accordingly, the light from the light sources may be converted into uniform surface light. Light sources used in the backlight unit may be point light sources, such as light emitting diodes (LEDs), or linear light sources, such as cold cathode fluorescent lamps (CCFLs).

Light emitted from a point light source or a linear light source is brighter at a region close to the light source than at other regions, and this region is referred to as a hot spot. The diffuser plate 100 according to an embodiment may remove hot spots and/or improve the uniformity in luminance using two optical sheets.

FIG. 2 illustrates a perspective view of a rear surface of a first optical sheet according to an embodiment.

The first optical sheet 110 may be a flat panel having a rear surface 112, upon which light is incident, and a front surface 114, from which light is emitted. A predetermined pattern may be provided on the rear surface 112, as described in detail below.

In the first optical sheet 110, light emitted from the light sources may be incident upon the rear surface 112 of the first optical sheet 110, and may be emitted from the front surface 114 of the first optical sheet 110. Thus, the first optical sheet 110 may enhance the uniformity in luminance between regions close to the light sources and regions distant from the light sources.

The predetermined pattern formed on the rear surface 112 may be formed by dot-shaped reflective regions 115 or dot-shaped transmissive regions 116. In this embodiment, the dot-shaped reflective regions 115 are disposed in the pattern, and remaining regions, i.e., regions except for the reflective regions 115, are the transmissive regions 116. The reflective regions 115 serve to reflect light, emitted from the light sources back to the light sources, and the transmissive regions 116 serve to transmit the light.

A region having a large number of the reflective regions 115 has relatively low luminance. A region having a large number of the transmissive regions 116 has relatively high luminance. Therefore, a large number of the reflective regions 115 may be disposed in the regions where hot spots are generated, and a large number of the transmissive regions 116 may be disposed in darker regions, thereby enhancing the uniformity in luminance.

The reflective regions 115, which serve to reflect light, may be formed by coating using a material that can reflect light. For example, the reflective regions 115 may be made of a material such as titanium oxide (e.g., TiO₂), silver, or calcium carbonate.

The transmissive regions 116 may be formed by remaining regions, i.e., regions surrounding the reflective regions 115. The first optical sheet 110 may be made of a transparent material, and the remaining regions of the rear surface 112 of the first optical sheet 110, i.e., regions except for where the reflective regions 115 are formed, form the transmissive regions 116.

Hereinafter, various disposition patterns of the reflective regions for one point light source will be described.

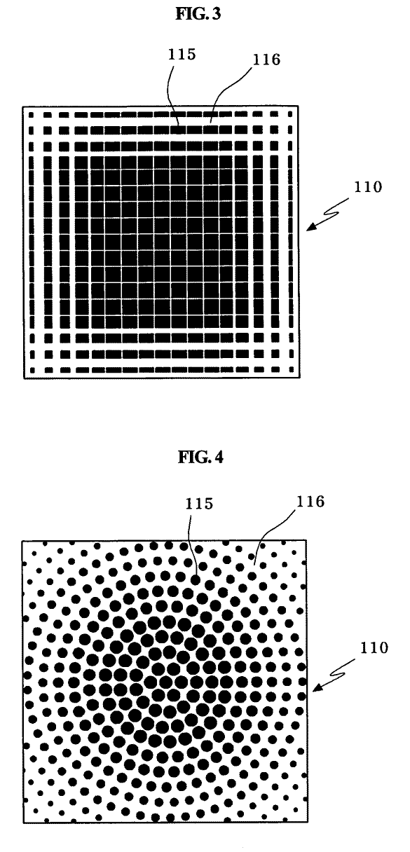

FIGS. 3 to 5 illustrate respective plan views of disposition patterns of dot-shaped reflective regions according to embodiments.

Referring to FIG. 3, each of the reflective regions 115 may have a rectangular dot shape, and the reflective regions 115 may be continuously disposed in a rectangular shaped-pattern.

The exact central portion of the pattern may coincide with a center of a corresponding light source. Further, the sizes of the dot-shaped reflective regions 115 may vary, e.g., gradually decrease, from the central portion of the pattern to the edge portion of the pattern. Thus, the area occupied by the reflective regions 115 per unit area, i.e., the area percentage of the optical sheet, may gradually decrease from the central portion of the pattern to the edge portion of the pattern.

Although FIG. 3 illustrates the reflective regions 115 as each having a rectangular dot shape, each of the reflective regions 115 may have other polygonal shapes, e.g., a triangular dot shape, a hexagonal dot shape, a circular dot shape, or an oval dot shape. Referring to FIG. 4, each of the reflective regions 115 has a circular dot shape, and the reflective regions 115 are disposed in a radial-shaped pattern, i.e., the reflective regions 115 form radii in the radial-shaped pattern. The size of the circular dot-shaped reflective regions 115 may be gradually decreased, and the interval between the reflective regions 115 may be gradually increased, progressing from the central portion of the pattern to the edge portion of the pattern. Thus, the area occupied by the transmissive regions 116 may be gradually increased from the central portion of the pattern to the edge portion of the pattern. In other implementations, the patterns formed by the disposition of the reflective regions 115 may have other shapes, e.g., polygonal shapes.

Referring to FIG. 5, each of the reflective regions 115 may have an oval dot shape, and the reflective regions 115 are disposed in a hexagonal shape pattern (honeycomb shape pattern). In the same manner as the earlier examples, the size of the oval dot-shaped reflective regions 115 may be gradually decreased from the central portion of the pattern to the edge portion of the pattern.

In these examples, the reflective regions 115 are configured such that the area occupied by the reflective regions 115 (per unit area of the optical sheet) is gradually decreased from the central portion of the pattern to the edge portion of the pattern. Thus, the amount of light transmitted by the first optical sheet gradually increases from the center of the light source to the edge of the light source, thereby serving to enhance the uniformity in luminance.

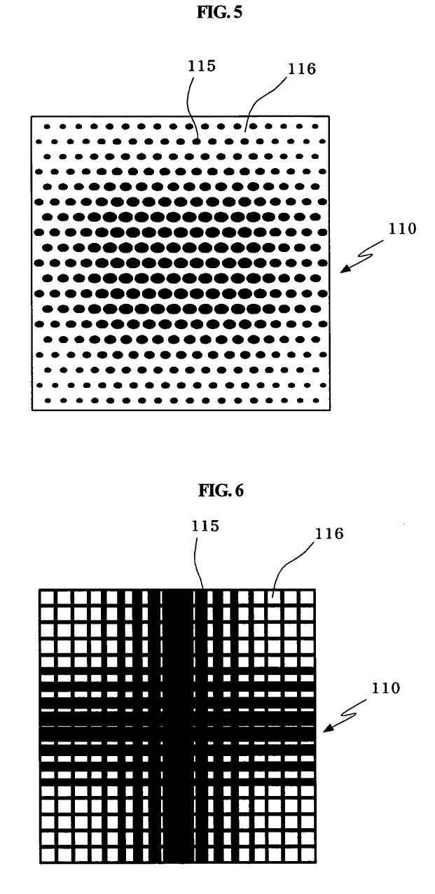

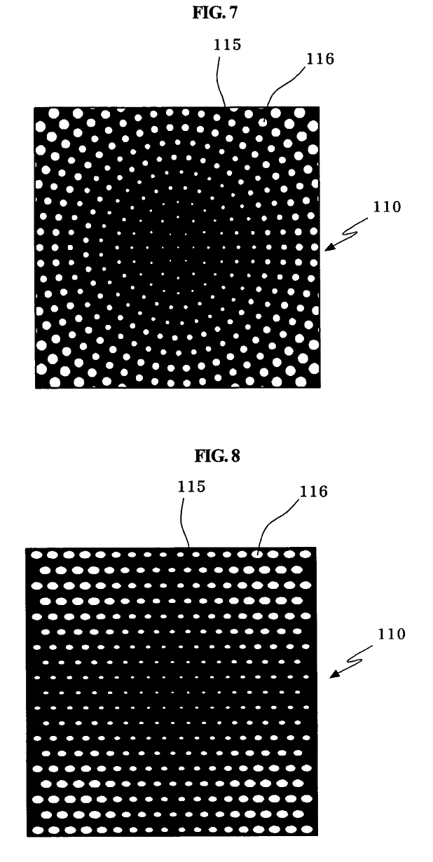

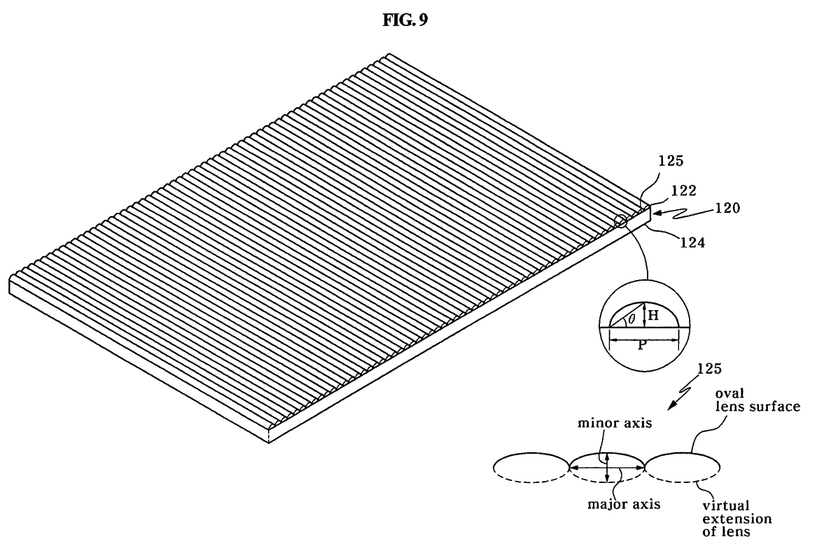

FIGS. 6 to 8 illustrate respective plan views of disposition patterns of dot-shaped transmissive regions according to embodiments. In particular, FIG. 6 illustrates the transmissive regions 116, each of which has a rectangular dot shape, disposed in a rectangular shape, FIG. 7 illustrates the transmissive regions 116, each of which has a circular dot shape, disposed in a radial shape, and FIG. 8 illustrates the transmissive regions 116, each of which has an oval dot shape, disposed in a hexagonal shape.

In case that the each of the transmissive regions 116 has a dot shape, the transmissive regions 116 may be configured such that the area occupied by the reflective regions 115 per unit area is gradually decreased from the central portion of the pattern to the edge portion of the pattern. That is, the change in area percentage occupied by the reflective regions 116 may be the same, regardless of whether the transmissive regions 116 have the dot shape or the reflective regions 116 have the dot shape. Thus, the transmissive regions 116 may be configured such that the size of the transmission parts 116 is the smallest at the central portion of the pattern, and may be gradually increased from the central portion to the edge portion of the pattern.

FIG. 9 illustrates a perspective view of a structure of a second optical sheet in accordance with an embodiment.

Referring to FIG. 9, the second optical sheet 120 may be formed as a flat panel having a rear surface 124, upon which light is incident, and a front surface 122, from which light is emitted. Lenticular lenses 125 may be provided on the front surface 122. The lenticular lenses 125 may have, e.g., a semi-circular cross-section, a semi-oval cross-section, etc.

Light incident upon the rear surface 124 of the second optical sheet 120 may be emitted from the front surface 112 of the first optical sheet 110. Thus, light radiated from the light sources may pass through the first optical sheet 110 so as to reach the rear surface 124 of the second optical sheet 120.

The second optical sheet 120 may serve to disperse images of the light sources, the images of the light sources being initially diffused by the first optical sheet 110, so as to provide more uniform luminance. In an implementation, the second optical sheet 120 may also condense light to enhance luminance.

The optical characteristics of the diffuser plate may be controlled by adjusting the ratio of pitch (P) to height (H) (in the case that the lenticular lenses 125 are directly adjacent to one another, so as to have a pitch equal to the width thereof) or the oblique side angle (θ) of the lenticular lenses 125.

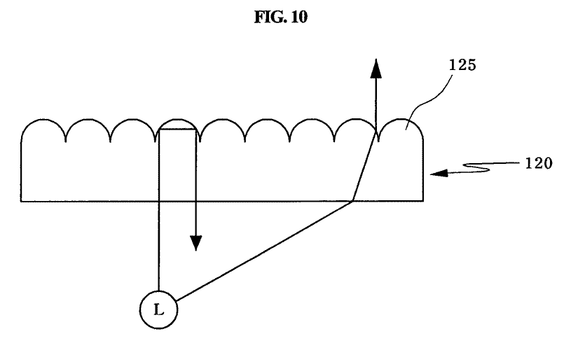

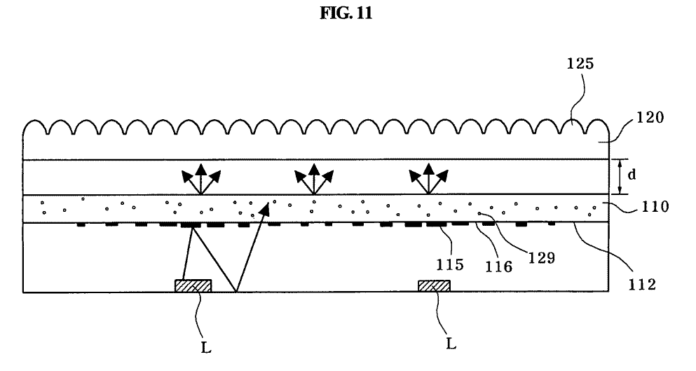

FIG. 10 illustrates a longitudinal-sectional view of a path of light passing through a second optical sheet in accordance with an embodiment.

Referring to FIG. 10, the second optical sheet 120 may totally reflect light emitted straight from light sources (L), and may transmit a large amount of the light through regions between the light sources (L), thus enhancing the uniformity in luminance.

When the lenticular lenses 125 have a semi-oval cross-section, the uniformity in luminance of the diffuser plate may be controlled by adjusting a length ratio of the oval major axis to the oval minor axis of the lenticular lenses 125. In another implementation, the uniformity in luminance of the diffuser plate may be controlled by adjusting a ratio of the pitch to the height of the lenticular lenses 125. The more the length ratio of the major axis to the minor axis of the oval of the lenticular lenses 125 is increased, the more the amount of the total reflection is increased. In addition, the more the oblique side angle (θ) of the lenticular lenses 125 is increased, the more the amount of the total reflection is increased. In the case that the lenticular lenses 125 have an oval cross-section, the oval major axis may be substantially equal to the pitch of the lenticular lenses.

Further, the more the distance between light sources and an optical sheet is narrowed, i.e., reduced, the more the amount of straight light from the light sources is correspondingly reduced. Therefore, in order to increase the amount of the total reflection, the oblique side angle (θ) of the lenticular lenses 125 may be increased and the length ratio of the major axis to the minor axis of the lenticular lenses 125 may be increased. In an implementation, the effective length ratio of the major axis to the minor axis of the lenticular lenses 125 is in the range of about 1:1 to about 5:1.

When the lenticular lenses 125 have a semi-circular cross-section, the uniformity in luminance of the diffuser plate may be controlled by adjusting the radius of curvature of the lenticular lenses 125, or by adjusting a ratio of the pitch to the height of the lenticular lenses 125. In an implementation, the effective ratio of the pitch to the height of the lenticular lenses 125 is in the range of about 1:0.5 to about 1:1. In an implementation, each lenticular lens may directly adjoin adjacent lenticular lenses. Alternatively, each lenticular lens may be spaced apart from adjacent lenticular lenses by a predetermined interval.

FIG. 11 illustrates a longitudinal-sectional view of a structure of a backlight unit according to an embodiment.

Referring to FIG. 11, the first optical sheet 110 and the second optical sheet 120 may be sequentially disposed over a plurality of the light sources (L).

Preferably, the first optical sheet 110 and the second optical sheet 120 are separated from each other by a predetermined interval (d). In another implementation, the first optical sheet 110 and the second optical sheet 120 may be adhered closely together.

Optically, when the interval (d) between the first optical sheet 110 and the second optical sheet 120 is large, the light sources (L) are not visible. Therefore, in this embodiment, the first and second optical sheets 110 and 120 are designed such that the first optical sheet 110 is located at a position close to the light sources (L) and the second optical sheet 120 is located at a position distant from the first optical sheet 110, to the extent that the thickness of the backlight unit allows. The interval (d) between the first optical sheet 110 and the second optical sheet 120 may be adjusted. Further, the first optical sheet 110 and the second optical sheet 120 may be adhered to each other closely or separated from each other, as described above.

The reflective regions 115 and the transmissive regions 116 may be formed on the rear surface 112 of the first optical sheet 110. In an implementation, optical beads 129 to diffuse and reflect light may be added to the inside of the first optical sheet 110. The beads 129 may have a size of several micrometers. The beads 129 may provide a Lambertian distribution, such that the luminance is substantially uniform in all directions. In another implementation, the transmissive and reflective regions 116, 115 may be formed on the front surface of the first optical sheet 110, e.g., in a case where no optical beads 129 are provided in the first optical sheet 110. In another implementation, the lenticular lenses 125 may be formed as recessed structures, e.g., inverse lens structures recessed into the rear surface of the second optical sheet 120. Also, the beads 129 may be provided in the first optical sheet 110.

Light emitted from the plurality of the light sources (L) may pass through the rear surface 112 of the first optical sheet 110 having the reflective regions 115 and the transmissive regions 116, such that the light is the brightest at the centers of the light sources (L) and is darker at regions between the light sources (L). Accordingly, the emitted light may have a more uniform luminance, and hot spots may be reduced or eliminated. Then, the light, the uniformity of which is enhanced to some degree, may pass through the second optical sheet 120 so that the image of the first optical sheet 110 is dispersed by the lenticular lenses 125. Accordingly, the uniformity of the light is further enhanced.

### COMPARATIVE EXAMPLE

LEDs were used as light sources to manufacture a diffuser plate. Four LEDs were disposed at an interval of 1 cm, and both illuminance distribution and luminance distribution of the diffuser plate having an area of 2 cm×2 cm were measured. The illuminance distribution and the luminance distribution of the diffuser plate having beads therein were simulated.

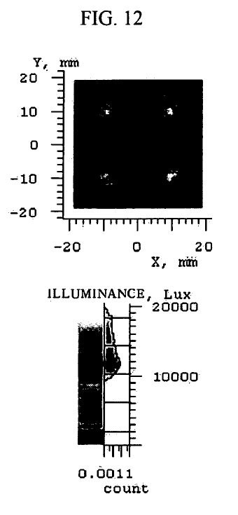

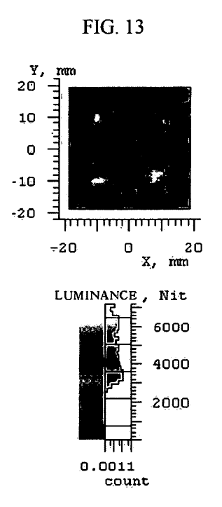

FIG. 12 illustrates a simulation result of illuminance distribution in the comparative example, and FIG. 13 illustrates a simulation result of luminance distribution in the comparative example. Referring to FIG. 12, illuminance was widely distributed from 10,000 Lux to 20,000 Lux and was not uniform, and hot spots were visible at the centers of the light sources. Referring to FIG. 13, luminance was widely distributed from 2,000 Nit to 6,000 Nit and was not uniform, and hot spots were visible at the centers of the light sources.

### EXPERIMENTAL EXAMPLE

The same light sources were disposed in the same way as for the comparative example, and the first optical sheet and the second optical sheet according to an embodiment were used to manufacture a diffuser plate.

The distance from a reflection plate of a backlight unit to the rear surface of the first optical sheet was 5 mm. The pattern of the reflective regions shown in FIG. 3 was used. The size of the central portion of the pattern was 0.8 mm and the size of the reflective regions was gradually decreased from the central portion of the pattern to the edge portion of the pattern. The reflective regions were made of silver.

The distance from the front surface of the first optical sheet to the rear surface of the second optical sheet was 9 mm. The pitch of the lenticular lenses was 140 μm, the height of the lenticular lenses was 70 μm, and the length ratio of the major axis to the minor axis of the lenticular lenses was 5:1.

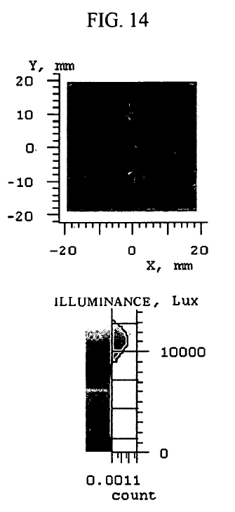

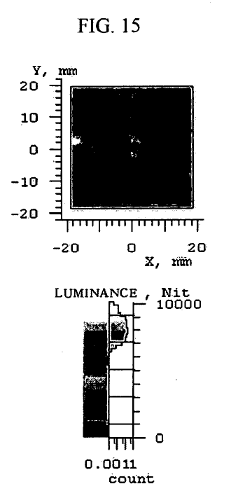

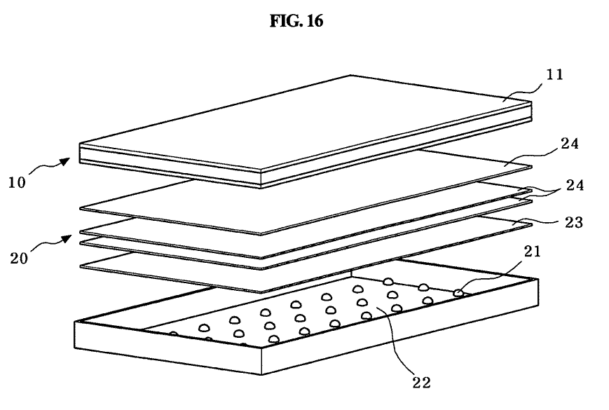

FIG. 14 illustrates a simulation result of illuminance distribution in the experimental example, and FIG. 15 illustrates a simulation result of luminance distribution in the experimental example. Referring to FIG. 14, illuminance was concentrated at 11,000˜12,000 Lux and exhibited excellent uniformity, and hot spots were not visible. Referring reference to FIG. 15, luminance was concentrated on 7,000˜9,000 Nit and exhibited excellent uniformity, and hot spots were not visible.

As described herein, reflective regions provided on the rear surface of the first optical sheet may reduce or eliminate hot spots, and lenticular lenses provided on the front surface of the second optical sheet may further disperse the image of the diffuser plate so as to provide more complete uniformity in luminance and concentrate light in a forward direction, thus enhancing luminance.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A diffuser plate, comprising:
a first optical sheet having a rear surface configured to receive light from a light source and having a front surface configured to provide light to a second optical sheet, the first optical sheet having a predetermined pattern formed by a plurality of transmissive regions and a plurality of reflective regions; and
a second optical sheet disposed in front of the first optical sheet, the second optical sheet including a rear surface configured to receive light from the first optical sheet, a front surface configured to emit light, and lenticular lenses on the front surface of the second optical sheet.

2. The diffuser plate as claimed in claim 1, wherein:
the plurality of transmissive regions of the predetermined pattern is on the rear surface of the first optical sheet, and
the plurality of reflective regions of the predetermined pattern is on the rear surface of the first optical sheet.

3. The diffuser plate as claimed in claim 1, wherein the first optical sheet and the second optical sheet are spaced apart by a predetermined interval.

4. The diffuser plate as claimed in claim 1, wherein the transmissive regions and the reflective regions combined occupy an entire surface of the first optical sheet.

5. The diffuser plate as claimed in claim 4, wherein an area percentage of the first optical sheet occupied by the reflective regions varies across the first optical sheet.

6. The diffuser plate as claimed in claim 5, wherein the area percentage of the first optical sheet occupied by the reflective regions is greater in areas directly over a light source than in areas farther away from the light source.

7. The diffuser plate as claimed in claim 1, wherein:
the reflective regions are dot-shaped regions, and
the transmissive regions are regions surrounding the dot-shaped reflective regions.

8. The diffuser plate as claimed in claim 7, wherein the dot-shaped reflective regions are arranged in a rectangular pattern, a radial pattern, or a hexagonal pattern.

9. The diffuser plate as claimed in claim 7, wherein an area percentage of the first optical sheet occupied by the dot-shaped reflective regions varies across the first optical sheet.

10. The diffuser plate as claimed in claim 1, wherein:
the transmissive regions are dot-shaped regions, and
the reflective regions are regions surrounding the dot-shaped transmissive regions.

11. The diffuser plate as claimed in claim 10, wherein the dot-shaped transmissive regions are arranged in a rectangular pattern, a radial pattern, or a hexagonal pattern.

12. The diffuser plate as claimed in claim 10, wherein an area percentage of the first optical sheet occupied by the dot-shaped transmissive regions varies across the first optical sheet.

13. The diffuser plate as claimed in claim 1, wherein the reflective regions include a reflective material having at least one of titanium oxide, silver, and calcium carbonate.

14. The diffuser plate as claimed in claim 1, wherein the lenticular lenses have a semi-circular or semi-oval cross-section.

15. The diffuser plate as claimed in claim 14, wherein:
the lenticular lenses have a semi-oval cross section, and
the semi-oval cross section has a ratio of major axis length to minor axis length of about 1:1 to about 5:1.

16. The diffuser plate as claimed in claim 1, wherein:
the lenticular lenses have a pitch and a height, and
a pitch:height ratio is about 1:0.5 to about 1:1.

17. The diffuser plate as claimed in claim 1, wherein:
the lenticular lenses are an array of cylindrical lenses having a semi-circular or semi-oval cross-section, and
a ratio of pitch to height of the lenticular lenses is uniform throughout the array.

18. The diffuser plate as claimed in claim 1, further comprising optical beads disposed between the transmissive regions and the lenticular lenses.

19. A backlight unit, comprising:
a light source unit including at least one light emitting device;
a diffuser plate; and
a reflection plate disposed to reflect light emitted from the light source unit toward the diffuser plate, wherein:
the diffuser plate includes:
a first optical sheet having a rear surface configured to receive light from a light source and having a front surface configured to provide light to a second optical sheet, the first optical sheet having a predetermined pattern formed by a plurality of transmissive regions and a plurality of reflective regions, and
a second optical sheet disposed in front of the first optical sheet, the second optical sheet including a rear surface configured to receive light from the first optical sheet, a front surface configured to emit light, and lenticular lenses on the front surface of the second optical sheet.

20. The backlight unit as claimed in claim 19, wherein an area percentage of the first optical sheet occupied by the reflective regions varies across the first optical sheet.

21. The backlight unit as claimed in claim 20, wherein the area percentage of the first optical sheet occupied by the reflective regions is greater in areas directly over a light source than in areas farther away from the light source.

22. A liquid crystal display, comprising:
a liquid crystal display panel having a viewing side and a backlit side; and
the backlight unit as claimed in claim 19 disposed adjacent to the backlit side.
